(19) United States
(12) Patent Application Publication
(10) Pub. No.: US 2026/0063426 A1
(43) Pub. Date: Mar. 5, 2026

(54) SLAM POSITIONING METHOD AND APPARATUS BASED ON TIMESTAMP CORRECTION, DEVICE AND STORAGE MEDIUM

(71) Applicant: Beijing Zitiao Network Technology Co., Ltd., Beijing (CN)

(72) Inventors: Yunfei FAN, Beijing (CN); Guidong WANG, Beijing (CN); Tao WU, Beijing (CN)

(21) Appl. No.: 19/320,524

(22) Filed: Sep. 5, 2025

(30) Foreign Application Priority Data
Sep. 5, 2024 (CN) 202411248391.9

(51) Int. Cl. G01C 21/16; G06F 3/01; G06F 3/0346; G06T 7/73

(52) U.S. Cl. CPC G01C 21/1656; G06T 7/73; G06F 3/012; G06F 3/0346; G06T 2207/30244

(57) ABSTRACT

A SLAM positioning method and apparatus based on timestamp correction, a device, and a storage medium are provided. The method includes: acquiring a time compensation value, an image observation result, and a system state of each sub-window in a current sliding window; constructing a SLAM model based on time compensation values, the image observation results and the system states of the sub-windows in the current sliding window, where the time compensation value is a time deviation between a time system of a camera and a time system of an IMU; solving the SLAM model to obtain a parameter to be estimated, including the system state and the time compensation value to be estimated of each sub-window in the current sliding window.

### CROSS-REFERENCE TO RELATED APPLICATION

The present application claims priority to Chinese Patent Application No. 202411248391.9, filed on Sep. 5, 2024, and the disclosure of the above patent application is incorporated herein by reference in its entirety as part of the present application.

### TECHNICAL FIELD

Embodiments of the present disclosure relate to the technical field of computer vision, and more particularly to a SLAM positioning method and apparatus based on timestamp correction, a device, and a storage medium.

### BACKGROUND

Simultaneous Localization and Mapping (SLAM) technology is widely used in the robot, Extended Reality (XR) equipment, autonomous driving and other fields. SLAM technology allows mapping devices to build environmental maps in real time through their own sensors (such as video cameras (or camera), laser radar, Inertial Measurement Unit (IMU), etc.) in unknown environments, and at the same time determine their locations in the map.

The SLAM system needs to obtain IMU data and image data. In most devices, the two types of data are obtained by independent modules, each module with its own system time, while the SLAM system needs to fuse and solve the two types of data, which requires both the IMU data and the image data to be under the same time system, that is, the temporal references corresponding to the timestamp of the IMU and the timestamp of the camera need to be consistent. However, in practice, due to hardware differences, algorithms and other reasons, the temporal references of the IMU and the camera are difficult to be consistent. Usually, the system time of the camera is slower than that of the IMU, which leads to lower positioning accuracy of the SLAM system.

### SUMMARY

Embodiments of the present disclosure provide a SLAM positioning method and apparatus based on timestamp correction, a device, and a storage medium, which can improve the accuracy of SLAM positioning.

According to a first aspect, an embodiment of the present disclosure provides a SLAM positioning method based on timestamp correction, which is applied to a terminal device including a camera and an inertial measurement unit (IMU), and the method includes:
acquiring a time compensation value, an image observation result and a system state of each sub-window in a current sliding window, where the current sliding window includes N sub-windows, N is greater than or equal to 2, the system state includes an IMU position and an IMU posture, and the image observation result includes an observation coordinate value of a landmark point captured by the camera at a system time of the sub-window;
constructing a SLAM model based on time compensation values, the image observation results the system states of the sub-windows in the current sliding window, where a camera system time corresponding to the system time tᵢ of an i-th sub-window in the SLAM mode is tᵢ−tdᵢ+td, where tdᵢ represents the time compensation value used to construct the i-th sub-window, td represents a time compensation value to be estimated, and the time compensation value is a time deviation between a time system of the camera and a time system of the IMU; and
solving the SLAM model to obtain a parameter to be estimated, where the parameter to be estimated includes: the system state and the time compensation value to be estimated of each sub-window in the current sliding window.

In some exemplary embodiments, before the constructing a SLAM model based on time compensation values, the image observation results and the system states of the sub-windows in the current sliding window, the method further includes:
acquiring an IMU pre-integration of each sub-window based on IMU data measured by the IMU, where the IMU pre-integration of the i-th sub-window is a pre-integration result of the IMU data between the system time of the i-th sub-window and the system time of an i+1-th sub-window;
the constructing a SLAM model based on time compensation values, the image observation results and the system states of the sub-windows in the current sliding window includes:
constructing an inertial measurement residual for each sub-window by the following formula:

$${r}_{I , i} = ( {X}_{{I}_{{t}_{i + 1}}} - {X}_{{I}_{{t}_{i}}} ) - {IMUS}_{{t}_{i}} ;$$

where r_{I,i} represents the inertial measurement residual for the i-th sub-window,

$${X}_{{I}_{{t}_{i}}}$$

represents the system state of the i-th sub-window,

$${X}_{{I}_{{t}_{i + 1}}}$$

represents the system state of the i+1-th sub-window, IMUSₜ_{ᵢ} represents the IMU pre-integration of the i-th sub-window;
determining the IMU posture and the IMU position at a time tᵢ−tdᵢ+td according to the time compensation value, the system state, and the time compensation value to be estimated of the sub-window in the current sliding window; and
constructing a visual measurement residual for the landmark point observed in the current sliding window by the following formula:

$${r}_{i , j} = {z}_{i , j} - π ( R ( {q}_{{t}_{i} - {td}_{i} + td} ) \cdot {}_{C}^{I} R , {P}_{{t}_{i} - {td}_{i} + td} + R ( {q}_{{t}_{i} - {td}_{i} + td} ) \cdot {}^{I} {P}_{C}^{} , {P}_{{L}_{i}} ) ,$$

where r_{i,j} represents the visual measurement residual of a j-th landmark point observed at the i-th sub-window, z_{i,j} represents the observation coordinate value of the j-th landmark point observed at the i-th sub-window,

$${}_{C}^{I} R$$

represents a rotation matrix or the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td. P_{L}_{ᵢ} represents a three-dimensional coordinate of the j-th landmark point, and π(-, -, -) represents a projection model of the camera.

In some exemplary embodiments, the solving the SLAM model to obtain a parameter to be estimated includes:
calculating Jacobian matrices of all the inertial measurement residuals and all the visual measurement residuals in the current sliding window with respect to the system states, respectively;
feeding all the inertial measurement residuals, all the visual measurement residuals, the Jacobian matrices corresponding to the inertial measurement residuals, the Jacobian matrices corresponding to the visual measurement residuals, and the system states in the current sliding window into a nonlinear optimizer for iterative optimization, to obtain the parameter to be estimated.

In some exemplary embodiments, the nonlinear optimizer includes g2o, ceres or GSTAM.

In some exemplary embodiments, the constructing a SLAM model based on time compensation values, the image observation results and the system states of the sub-windows in the current sliding window includes:
determining the IMU posture and the IMU position at a time tᵢ−tdᵢ+td according to the time compensation value, the system state, and the time compensation value to be estimated of the sub-window in the current sliding window; and
constructing a visual measurement residual of an observed landmark point in the current sliding window by the following formula:

$${r}_{i , j} = {z}_{i , j} - π ( R ( {q}_{{t}_{i} - {td}_{i} + td} ) \cdot {}_{C}^{I} R , {P}_{{t}_{i} - {td}_{i} + td} + R ( {q}_{{t}_{i} - {td}_{i} + td} ) \cdot {}^{I} {P}_{C}^{} , {P}_{{L}_{i}} ) ,$$

where r_{i,j} represents the visual measurement residual of a j-th landmark point observed at the i-th sub-window, z_{i,j} represents the observation coordinate value of the j-th landmark point observed at the i-th sub-window,

$${}_{C}^{I} R$$

represents a rotation matrix of the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents a three-dimensional coordinate of the j-th landmark point, and π (-, -, -) represents a projection model of the camera.

In some exemplary embodiments, the solving the SLAM model to obtain a parameter to be estimated includes:
calculating Jacobian matrices of the visual measurement residuals in the current sliding window with respect to the system states, respectively;
performing Kalman-related filtering processing on all the visual measurement residuals, the Jacobian matrices corresponding to the visual measurement residuals, and the system states in the current sliding window, to obtain the parameter to be estimated.

In some exemplary embodiments, the Kalman-related filtering processing includes Kalman filtering processing or extended Kalman filtering processing.

In some exemplary embodiments, the determining the IMU posture and the IMU position at a time tᵢ−tdᵢ+td according to the time compensation value, the system state, and the time compensation value to be estimated of the sub-window in the current sliding window includes:
determining the IMU posture at the time tᵢ−tdᵢ+td according to the IMU posture, an IMU velocity, an IMU gyroscope value, the time compensation value, and the time compensation value to be estimated of the i-th sub-window; and
determining the IMU position at the time tᵢ−tdᵢ+td according to the IMU position, the IMU velocity, the IMU gyroscope value, the time compensation value, and the time compensation value to be estimated of the i-th sub-window.

In some exemplary embodiments, the IMU posture at the time tᵢ−tdᵢ+td satisfies the following formula:

$${q}_{{t}_{i} - {td}_{i} + td} = {q}_{{t}_{i}} \cdot T ( I + {[ {ω}_{{t}_{i}} * ( td - {dt}_{i} ) ]}_{x} ) ,$$

wherein qₜ_{ᵢ} represents the IMU posture corresponding to the i-th sub-window, I represents a unit matrix, ωₜ_{ᵢ} represents the IMU gyroscope value measured at the system time of the i-th sub-window, and T(•) represents a conversion from the rotation matrix to a quaternion operation;
the IMU position at the time tᵢ−tdᵢ+td satisfies the following formula:

$${P}_{{t}_{i} - {td}_{i} + td} = {P}_{{t}_{i}} + {V}_{{t}_{i}} ( td - {dt}_{i} ) ,$$

where Pₜ_{ᵢ} represents the IMU position corresponding to the i-th sub-window, and Vₜ_{ᵢ} represents the IMU velocity of the i-th sub-window.

In some exemplary embodiments, the system time is a time under the time system of the IMU used as a reference time system.

In some exemplary embodiments, the system state further includes at least one of: an IMU velocity, an IMU accelerometer bias, an IMU gyroscope bias, and a three-dimensional coordinate of the landmark point.

In some exemplary embodiments, an observation value of the landmark point is a pixel coordinate of the landmark point, or the observation value of the landmark point is a normalize coordinate of the landmark point in a plane of the camera.

According to a second aspect, an embodiment of the present disclosure provides a SLAM positioning apparatus based on timestamp correction, which is applied to a terminal device including a camera and an inertial measurement unit (IMU), and the apparatus includes:
an acquisition module, configured to acquire a time compensation value, an image observation result and a system state of each sub-window in a current sliding window, where the current sliding window includes N sub-windows, N is greater than or equal to 2, the system state includes an IMU position and an IMU posture, and the image observation result includes an observation coordinate value of a landmark point captured by the camera at a system time of the sub-window;
a modeling module, configured to construct a SLAM model based on time compensation values, image observation results and the system states of the sub-windows in the current sliding window, where a camera system time corresponding to the system time tᵢ of an i-th sub-window in the SLAM mode is tᵢ−tdᵢ+td, where tdᵢ represents the time compensation value used to construct the i-th sub-window, td represents a time compensation value to be estimated, and the time compensation value is a time deviation between a time system of the camera and a time system of the IMU; and
a solving module, configured to solve the SLAM model to obtain a parameter to be estimated, where the parameter to be estimated includes: the system state and the time compensation value to be estimated of each sub-window in the current sliding window.

According to a third aspect, an embodiment of the present disclosure provides a terminal device including a processor and a memory, the memory is configured to store computer program, and the processor is configured to call and execute computer program stored in the memory, to perform the method according to the first aspect.

According to a fourth aspect, an embodiment of the present disclosure provides a computer-readable storage medium having computer program stored thereon, where the computer program causes a computer to perform the method according to the first aspect.

According to a fifth aspect, an embodiment of the present disclosure provides a computer program product including computer program, and the computer program, when executed by a processor, is configured to perform the method according to the first aspect.

### BRIEF DESCRIPTION OF DRAWINGS

In order to more clearly explain the technical solutions in the embodiments of the present disclosure, the accompanying drawings that need to be used in the description of the embodiments will be briefly introduced below, and it is obvious that the accompanying drawings in the following description are only some embodiments of the present disclosure, and for those skilled in the art, other accompanying drawings can be obtained from these accompanying drawings without making creative labor.

FIG. 1 is a schematic diagram of an application scenario to which an embodiment of the present disclosure is applicable.

FIG. 2 is a timing diagram of image and IMU data in an existing SLAM system;

FIG. 3 is a flowchart of a SLAM positioning method based on timestamp correction according to a first embodiment of the present disclosure.

FIG. 4 is a timing diagram of modified image and IMU data of a SLAM system;

FIG. 5 is a schematic structural diagram of a SLAM positioning apparatus based on timestamp correction according to a fourth embodiment of the present disclosure.

FIG. 6 is a schematic structural diagram of a terminal device according to a fifth embodiment of the present disclosure.

### DETAILED DESCRIPTION

Hereinafter, the technical solutions in the embodiments of the present disclosure will be clearly and completely described with reference to the accompanying drawings in the embodiments of the present disclosure, and it is obvious that the described embodiments are only some embodiments of the present disclosure, but not all embodiments. Based on the embodiments in the present disclosure, all other embodiments obtained by those skilled in the art without making creative efforts fall within the scope of protection of the present disclosure.

It should be noted that the terms “first”, “second”, and the like in the description, the claims and the drawings of the present disclosure are used to distinguish similar objects, and are not necessarily used to describe a specific order or sequence. It should be understood that the data so used may be interchangeable where appropriate so that the embodiments of the present disclosure described herein can be practiced in an order other than those illustrated or described herein. Furthermore, the terms “comprising/including”, “having” and any variations thereof are intended to cover a non-exclusive inclusion, for example, a process, method, system, product, or terminal device comprising a series of steps or units is not necessarily limited to those steps or units that are clearly listed, but may include other steps or units that are not clearly listed or inherent to these processes, methods, products, or devices.

An embodiment of the present disclosure provides a sensor timestamp calibration method of a SLAM system, which is applied to a terminal device using SALM technology.

SLAM is a technology that is widely used in the field of robot. It allows robot to build an environment map in real time through its own sensors (such as cameras, laser radar, etc.) in unknown environments, and at the same time determine its position in the map.

SLAM technology has a wide application prospect in autonomous driving, Unmanned Aerial Vehicle (UAV) navigation, Extended Reality (XR) and other fields. Among them, the XR technology includes Virtual Reality (Virtual Reality, VR), Augmented Reality (Augmented Reality, AR) and Mixed Reality (Mixed Reality, MR).

SLAM technologies are mainly divided into two categories: vision-based SLAM (Visual SLAM, referred to as VSLAM) and laser radar-based SLAM (Lidar SLAM, referred to as LISLAM).

VSLAM uses a camera as the main sensor, and the camera can capture rich environmental information. VSLAM usually involves steps such as feature point extraction, feature matching, pose estimation, and map construction. LISLAM uses laser radar (Light Detection and Ranging) as a sensor, and laser radar is able to measure the distance from a point in the surrounding environment to the robot, and generate point cloud data. LISLAM mainly focuses on the registration of point clouds, pose estimation and map construction.

The terminal device involved in the embodiments of the present disclosure may adopt VSLAM technology or LISLAM technology, and the terminal device may also adopt a fusion system integrated with more sensors, for example, a Global Positioning System (GPS), a Real-Time Kinematic (RTK) positioning technology, a wheel speed sensor, and the like. The embodiment of the present disclosure mainly takes a VSLAM that integrates a video camera (or a camera) and an Inertial Measurement Unit (IMU) as an example.

Hereinafter, the definitions of symbols involved in the embodiments of the present disclosure will be described.
t₀, t₁, t₂, . . . , tₙ represents the time under a time system of the IMU.
T₀, T₁, T₂, . . . , Tₙ represents the time under a time system of the camera, which is also known as [symbol] ge timestamping system.

In the embodiment of the present disclosure, rotation matrices and quaternions are used in a hybrid manner, because quaternions and rotation matrices can be converted to each other, and the conversion relationship between quaternions and rotation matrices can be expressed as:

$$R = ( q ) , q = T ( R ) ,$$

where R is the rotation matrix, and q is the quaternion of an operation corresponding thereto.

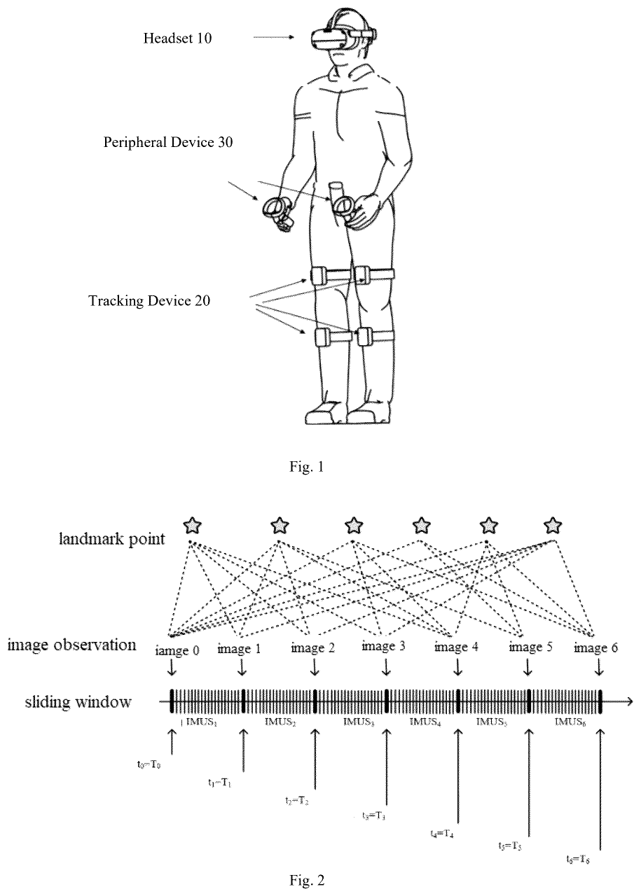

By way of example, FIG. 1 is a schematic diagram of an application scenario to which embodiments of the present disclosure are applicable. As shown in FIG. 1, the application scenario 100 may include a headset 10 and a tracking device 20. Also, communication may occur between the headset 10 and the tracking device 20. The headset 10 is also referred to as a head-mounted display device, and the tracking device 20 is also referred to as a motion capture device or a tracker.

In some implementations, the headset 10 may be an HMD, such as a head-mounted display in a VR all-in-one machine, and the present embodiment does not make any limitation on this.

Further, the headset 10 is provided with a camera to collect surrounding environment data by the camera, and tracking and positioning are performed by using a SLAM algorithm based on the collected surrounding environment data. Note that the number of cameras may be at least one, and FIG. 1 illustrates the case in which the number of cameras is four as an example. Further, the type of the camera described above may be a fisheye camera, an ordinary camera, and other types of cameras, and the present disclosure does not impose any limitation thereon.

In the embodiment of the present disclosure, the tracking device 20 and the headset 100 include an IMU, and the IMU may be a six-axis IMU or a nine-axis IMU, which is not specifically limited herein. The IMU is used to measure the inertial data of the device where it's located, and the inertial data obtained by the IMU measurement is hereinafter referred to as IMU data.

In some implementations, the tracking device 20 may be an optical tracker, and the tracking device 20 may be worn on different parts of the human body, such as limbs, torso, shoulders, waist, and the like of the human body. The limb data collected by the tracking device 20 worn on a human limb may be 3-Degrees-of-Freedom (3-Dof) data or 6-Degrees-of-Freedom (6-Dof) data.

Optionally, the upper limb of the human body may not only wear the tracking device 20 but also a peripheral device 30. For example, the peripheral device 30 is worn on the hand and/or arm of a human body. Then, the movement data of the upper limb of the human body is collected by the peripheral device 30 and transmitted to the headset 10, thereby realizing the tracking of the movement of the upper limb of the human body. The wearing mode of the peripheral device 300 is detailed in FIG. 2.

In some implementations, the peripheral device 30 may be, but is not limited to, a handle, a glove, a bracelet, a wristband, a ring, and other wearable devices. Further, the peripheral device 30 is provided with an IMU, and the IMU can provide 6-Dof data including the position of the upper limb of the human body and the posture of the upper limb of the human body.

It should be understood that the headset 10, the tracking device 20, and the peripheral device 30 shown in FIG. 1 are merely schematic and are not intended to be specific limitations on the present disclosure.

The SLAM positioning method based on timestamp correction provided by the embodiment of the present disclosure is applied to a terminal device, and the terminal device is not limited to the headset shown in FIG. 1, and may also include various robots, autonomous vehicle (AV), aerial vehicles, and the like.

In a SLAM system of the terminal device, the frame rate (usually about 10 Hz-33 Hz) of the image is usually less than the frame rate (usually about 100 Hz-1000 Hz) of the IMU. Therefore, in an optimized SLAM, the IMU data is usually pre-integrated, and then fused with image measurement results for calculation.

In some related techniques, the SLAM system employs a sliding window mechanism, and the sliding window includes a plurality of sub-windows, and each sub-window corresponds to a multi-dimensional system state vector. Exemplarily, the system state vector includes a posture, a position, a velocity, an accelerometer bias, and a gyroscope bias of the IMU.

FIG. 2 is a timing diagram of image and IMU data of an existing SLAM system. As shown in FIG. 2, the size of the sliding window is 7, that is, one sliding window includes 7 sliding sub-windows, a system state is defined for each sub-window, each sub-window corresponds to a system time, the system time corresponding to sub-window 0 is t0, the system time corresponding to sub-window 1 is t1, and so on, the system time corresponding to sub-window 6 is t6.

In each sub-window, the IMU performs multiple acquisitions to collect a plurality of pieces of IMU data, and performs pre-integration on the plurality of pieces of IMU data collected in each sub-window to obtain the IMU pre-integration of each sub-window. The IMU pre-integration of each sub-window can also be understood as the pre-integration result of the IMU data between the system time of the sub-window and the system time of the next sub-window.

At the system time of each sub-window, the camera will also photograph multiple landmarks in the environment to obtain the corresponding images. The SLAM system obtains the image observation results based on the captured images, and combines the image observation results, the system status and the IMU pre-integration to jointly build a SLAM model for calculation.

In the SLAM system, the camera and the IMU are independent modules, each with its own time system, while the SLAM system needs to fuse the two modules for calculation. Therefore, the IMU data and the image data need to be represented under the same temporal reference framework. That is to say, the temporal references corresponding to timestamps of the IMU and the camera need to be consistent, and it's now allowed for an obvious millisecond error between the timestamp of the IMU and the timestamp of the image to occur at the same time moment.

However, in actual implementation, the temporal reference of the IMU and the temporal reference of the camera cannot be completely consistent. When the temporal reference of the camera is not consistent with the temporal reference of the IMU, there may be the case that, time T₀ that seems to belong to a time system of an image can find its corresponding value in a temporal reference framework of the IMU. Although the timestamps (that is, the reading of the time value) of the two are consistent, T₀ under the time system of the image and T₀ under the time system of the IMU do not correspond to the same actual time point due to the different temporal references of the two.

Assuming that the time system of the image needs to be corrected by td, so as to be aligned with time system of the IMU, the timestamp of the image acquisition time Tᵢ after being corrected by td is timestamp (i.e., Tᵢ+td) at which the image is acquired under the time system of the IMU, while td is just the deviation between the time system of the IMU and the time system of the image, which can also be referred to as the time compensation value or the timestamp compensation value, indicating that the time system of the image is slower than the time system of the IMU by td seconds.

It should be clarified that the time system of the image in the embodiment of the present disclosure is the time system of the camera, and the two can be replaced with each other.

The embodiment of the present disclosure provides a SLAM positioning method based on timestamp correction, which enables the temporal reference of the IMU and the temporal reference of the camera in the SLAM system to be consistent. With this method, the time compensation value between the time system of the IMU and the time system of the camera is continuously optimized and is used to compensate the time system of the camera (or described as compensating the timestamp of the image), and the time system of the camera after compensation is used to model the SLAM model, thereby enabling the estimation result of the SLAM system to be more accurate.

After introducing the application scenario of the embodiment of the present disclosure, a SLAM positioning method based on timestamp correction provided by the embodiment of the present disclosure will be described in detail below with reference to the accompanying drawings.

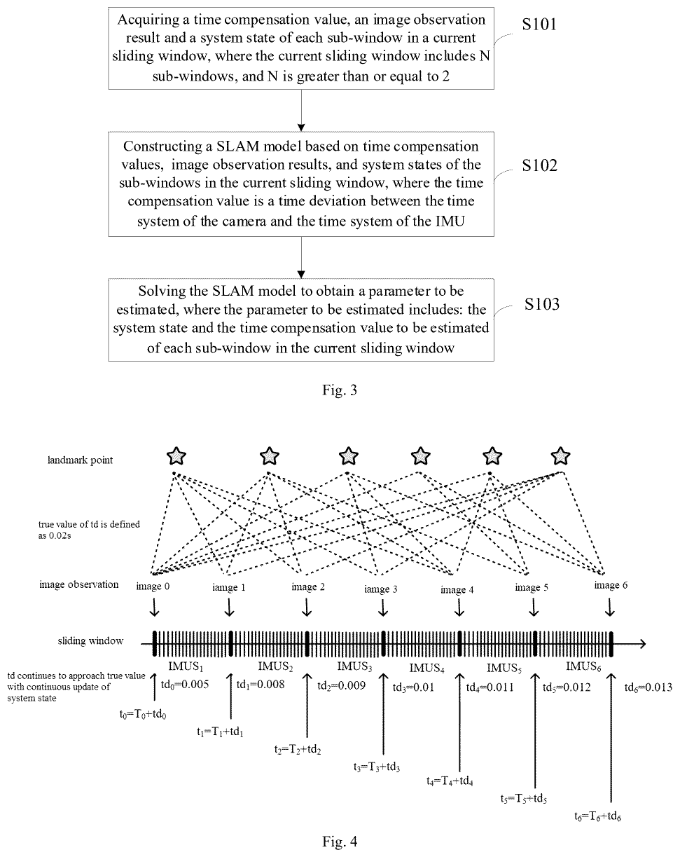

FIG. 3 is a flowchart of a SLAM positioning method based on timestamp correction provided in a first embodiment of the present disclosure. The execution body of the present embodiment is a terminal device, and the terminal device may be a headset (i.e., an XR device), a robot, an Unmanned Aerial Vehicle (UAV), or the like. As shown in FIG. 3, the method of the present embodiment includes the following steps.

S101, acquiring a time compensation value, an image observation result and a system state of each sub-window in a current sliding window, where the current sliding window includes N sub-windows, and N is greater than or equal to 2.

The terminal device includes a camera and an IMU, and the SLAM system of the terminal device [symbol] forms SLAM positioning and mapping based on the image captured by the camera and the IMU data [symbol] ected by the IMU. Among them, the time system of the camera is different from the time system of the IMU, and the time deviation between the time system of the camera and the time system of the IMU is defined as td, td is also referred to as the time compensation value.

In this embodiment, td is estimated together with the system state. Every time the SLAM system [symbol] forms system state estimation, a new td will be obtained accordingly. That is, td is continuously [symbol] lated as the sliding window slides, and every time the sub-window slides, a new td will be obtained. Therefore, each sub-window will correspond to one td.

Every time the SLAM system estimates a time compensation value of a sub-window, it stores the corresponding relationship between the sub-window and the time compensation value. The stored time compensation value of the sub-window is used for subsequent state estimation. Therefore, when the state estimation is performed by using the current sliding window, the time compensation value of the sub-window in the current sliding window can be read from the internal memory of the device.

The system state of each sub-window in the current sliding window is the system state obtained from the last estimation. The system state of each sub-window includes the position and posture of the IMU, and the position and posture of the IMU can also be referred to as the pose of the IMU for short.

Optionally, the system state of the sub-window further includes at least one of the following parameters: a velocity of the IMU, an accelerometer bias of the IMU, a gyroscope bias of the IMU, and three-dimensional coordinates of a landmark point.

It will be appreciated that when the SLAM employs different state estimation methods, the system state of the sub-window may include different parameters. Commonly used state estimation methods of the SLAM include: nonlinear optimization iterative solution and Kalman-related filtering solution. Kalman-related filtering solution includes Kalman Filtering (KF) and Extended Kalman Filtering (EKF).

Exemplarily, when the SLAM utilizes the nonlinear optimization iterative solution, the system state of the sub-window may include the position, posture, velocity, accelerometer bias, gyroscope bias, and three-dimensional coordinates of the IMU. Among them, the posture of the IMU is a 4-dimensional vector, and the position, velocity, accelerometer bias and gyroscope bias of the IMU are 3-dimensional vectors, respectively.

When the SLAM utilizes the Kalman-related filtering solution, the system state of the sub-window may include the position and posture of the IMU.

The image observation result of the sub-window includes the observation coordinate values of the landmark point captured by the camera at the system time of the sub-window, and the environment includes multiple landmark points, which are also referred to as feature points in the image. The landmark points included in the images captured by the camera at different times may be different. For example, when six landmark points are included in the environment, the image (i.e., image 1) captured by the camera at the time T₁ may only include the first three landmark points, and the image (i.e., image 2) captured by the camera at the time T₂ may include all the landmark points.

The observation coordinate value of the landmark point can be the pixel coordinate of the landmark point or the normalize coordinate of the landmark point in the plane of the camera. The pixel coordinate of the landmark point is the coordinate that has not been subject to distortion removal processing, and the normalize coordinate of the landmark point is the coordinate that has been subject to the distortion removal processing. The terminal device can directly obtain the pixel coordinates of the landmark point from the image captured by the camera, then perform distortion removal processing on the pixel coordinates of the landmark point by using intrinsic parameters of the camera, then perform normalizing processing on the coordinates that have been subject to distortion removal processing, and convert them to a normalized plane.

The terminal device can determine the landmark points in each image captured by the camera through a target tracking method. There may be multiple landmark points in each image. After identifying the landmark points in the image, the observation coordinate values of each landmark point are further obtained.

FIG. 4 is a timing diagram of the corrected image and the IMU data of the SLAM system. As [symbol] wn in FIG. 4, each sub-window corresponds to a time compensation value. As a continuous update of [symbol] system state, the time compensation value td continues to be updated towards the true value. For example, the true value of the time compensation value td is 0.02 second (i.e., 20 milliseconds (ms)).

The system time of the i-th sub-window is tᵢ=Tᵢ+tdᵢ, where Tᵢ represents the time of the i-th [symbol] ge under the camera's time system, and tdᵢ represents the time compensation value corresponding to [symbol] system time tᵢ of the i-th sub-window. Among them, the system time of the i-th sub-window refers to the time of the i-th sub-window under the reference time system of the SLAM system. The reference time system of the SLAM system can be the time system of the IMU. In the case where the reference time system of the SLAM system is the time system of the IMU, when the SLAM system performs system state estimation, it is necessary to align the time systems of all sensors involved in the system state estimation to the time system of the IMU, that is, the SLAM system performs state estimation based on the time system of the IMU.

It is to be understood that the reference time system of the SLAM system may also be a time system of other sensors in the SLAM system. The embodiment of the present disclosure is described with reference to the case where the reference time system of the SLAM system is the time system of the IMU, by way of example, which does not constitute any limitation to the present disclosure. The principle of the timestamp correction method of the present embodiment is the same regardless of which sensor's time system is taken as the reference time system of the SLAM system.

When the system time of the IMU is to, the td that the SLAM system can estimate is td₀, then [symbol] most accurate (or latest) td₀ as estimated at the time to is used to collect the IMU data, collect the [symbol] ge tracking information, and obtain the system state.

When the system time of the IMU is t₁, the td that the SLAM system can estimate is td₁, then [symbol] most accurate (or latest) td₁ as estimated at the time t₁ is used to collect the IMU data, collect the [symbol] ge tracking information, and obtain the system state.

The situations of times t₂, t₃, t₄, t₅ and t₆ are similar to that of times t₀ and t₁, and will not be [symbol] eated here. Among them, the system time of the IMU refers to the time under the time system of the [symbol] U. When the time system of the IMU is the reference time system of the SLAM system, and when the system time of the IMU is tᵢ, the entire time system of the SLAM system also goes to tᵢ.

The purpose of performing the above operations at time tᵢ in the embodiment of the present [symbol] lication is: the latest image timestamp that can be obtained at time tᵢ is Tᵢ: the latest image timestamp [symbol] the latest tdᵢ is exactly the same as tᵢ (i.e., tᵢ=Tᵢ+tdᵢ). Therefore, the collection of IMU data, the collection of image tracking information, and the acquisition of system state are required to be performed at this time.

The collection of the image tracking information includes: identifying the landmark point in the newly acquired image, acquiring the observation coordinate value of the landmark point in the newly acquired image, and associating the observation coordinate value of the landmark in the newly acquired image with the sub-window. Among them, associating the observation coordinate value of the landmark point in the newly acquired image with the sub-window can be understood as establishing a corresponding relationship between the observation coordinate value of the landmark point in the newly acquired image and the time system of the sub-window, the system state of the sub-window and the time compensation value of the sub-window. In this way, when the sub-window is used subsequently to perform state estimation, all the information associated with the sub-window can be found.

S102, constructing a SLAM model based on time compensation values, image observation results, and system states of the sub-windows in the current sliding window, where the time compensation value is a time deviation between the time system of the camera and the time system of the IMU.

In this embodiment, the time compensation value td is modeled together with the system state, so [symbol] continuous iterative optimization calculation can be performed on td. In one implementation, the [symbol] ut X for constructing the SLAM model includes the system state of each sub-window in the sliding window, the time compensation value to be estimated, and the three-dimensional coordinates of all observed landmark points in the sliding window. In this method, the three-dimensional coordinates of the landmark point are independent of the system state, that is, the three-dimensional coordinates of the landmark point are not included in the system of the sub-window. Among them, the input X of the SLAM model is also the parameters to be estimated of the SLAM system. X can be expressed as:

$${{\text{?}}_{{I}_{{t}_{0}}}^{T} , {X}_{{I}_{{t}_{1}}}^{T} , … , {X}_{{I}_{{t}_{N - 1}}}^{T} , td , {P}_{{L}_{0}}^{T} , … , {P}_{{L}_{j}}^{T} ]}^{T} .$$

$$\text{?} \text{indicates text missing or illegible when filed}$$

Among them,

$${X}_{{I}_{{t}_{i}}}$$

represents the system state of the i-th sub-window, P_{L}_{ⱼ} represents the three- [symbol] ensional coordinates of the j-th landmark point, td represents the time compensation value to be [symbol] mated, (•)^{T} represents the transposition operation, and the matrix is converted from columns to rows through the transposition operation.

Optionally, P_{L}_{ⱼ} can be the three-dimensional coordinates of the j-th landmark point in the world [symbol] rdinate system, or it can be the three-dimensional coordinates of the j-th landmark point in the camera [symbol] rdinate system, or it can be the three-dimensional coordinates of the j-th landmark point in the IMU coordinate system. It can be understood that these three coordinate systems can be converted into each other. Therefore, after knowing the three-dimensional coordinates of the j-th landmark point in any coordinate system, its three-dimensional coordinates in other coordinate systems can be obtained according to the conversion relationship between the coordinate systems.

In another implementation, the input X for constructing the SLAM model includes the system state and the time compensation value to be estimated of each sub-window in the sliding window. In this method, the system state of the sub-window includes the three-dimensional coordinates of the j-th landmark point.

In an optional implementation, the system state

$${X}_{{I}_{{t}_{i}}}$$

of the i-th sub-window can be expressed as:

$${\text{?} {q}_{{I}_{{t}_{i}}}^{T} , {P}_{{I}_{{t}_{i}}}^{T} , {V}_{{I}_{{t}_{i}}}^{T} , {b}_{{a}_{{t}_{i}}}^{T} {v}_{{g}_{{t}_{i}}}^{T} ]}^{T} ,$$

$$\text{?} \text{indicates text missing or illegible when filed}$$

$${\text{?}}_{{I}_{{t}_{i}}}$$

$$\text{?} \text{indicates text missing or illegible when filed}$$

represents the IMU posture (as quaternion),

$${P}_{{I}_{{t}_{i}}}$$

represents the IMU position,

$${V}_{{I}_{{t}_{i}}}$$

represents the [symbol] U velocity,

$${b}_{{a}_{{t}_{i}}}$$

represents the accelerometer bias,

$${b}_{{q}_{{t}_{i}}}$$

represents the gyroscope bias, (•)^{T} represents [symbol] transposition operation, and where the accelerometer bias is used to correct the acceleration measured by the accelerometer, and the gyroscope bias is used to correct the angular velocity measured by the gyroscope.

In this embodiment, the system time of the IMU in the constructed SLAM model is the time [symbol] er the time system of the IMU, and the camera system time (or the image system time) is the time [symbol] rected by using the time compensation value, where the camera system time of the i-th sub-window refers to the time of the image of the i-th sub-window under the time system of the camera. Specifically, the camera system time corresponding to the system time of the i-th sub-window is: tᵢ−tdᵢ+td, where tdᵢ represents the time compensation value used to construct the i-th sub-window (system time tᵢ), td represents the time compensation value to be estimated, and tᵢ−tdᵢ+td is the camera system time at time tᵢ under the time system of the IMU.

Since the time compensation value gradually approaches the true value as the system state [symbol] tinues to update, for each sub-window in the current sliding window, the time compensation value of [symbol] sub-window is a historical value, and the historical value of the time compensation value is inaccurate relative to the latest value. When constructing the SLAM model, it is expected to use the latest time compensation value. At the time tᵢ, there is tᵢ=Tᵢ+tdᵢ. Since tdᵢ is inaccurate, Tᵢ is obtained by subtracting tdᵢ from tᵢ, then adding the latest time compensation value td to Tᵢ, it gives the accurate tᵢ. In this way, the camera system time at the time tᵢ under the time system of the IMU can be obtained as tᵢ−tdᵢ+td.

Commonly used state estimation methods of SLAM include nonlinear optimization iterative solution and Kalman-related filtering solution. Among them, the SLAM models constructed by different estimation methods are different, and the SLAM models constructed by the two estimation methods and the solving process are described in detail in the following examples, respectively.

S103, solving the SLAM model to obtain a parameter to be estimated, where the parameter to be estimated includes: the system state and the time compensation value to be estimated of each sub-window in the current sliding window.

Different SLAM models can be constructed according to different estimation methods, and the solving process is also different. By solving the SLAM model, the parameter to be estimated is obtained. Different from the prior art, the parameter to be estimated includes the time compensation value to be estimated, and the time compensation value to be estimated is continuously optimized with the system state.

Optionally, the parameter to be estimated further includes three-dimensional coordinates of the observation point, or may also include other parameters, such as extrinsic parameters of the camera, intrinsic parameters of the camera, etc., which is not limited in the embodiment of the present disclosure. In the embodiment of the present disclosure, the time compensation value is mainly added to the parameter to be estimated, so that the time compensation value can be estimated or calibrated online.

After the system state of each sub-window is estimated, the camera pose, the three-dimensional coordinates of observation points, etc., can be further estimated according to the system state of the sub-window. It should be noted that the three-dimensional coordinates of observation points can also be estimated together with the system state. The terminal device performs positioning and mapping according to the system state, the camera pose, the three-dimensional coordinates of observation points and the like as estimated.

In the present embodiment, the time compensation value, the image observation result, and the system state of each sub-window in the current sliding window are obtained, where he current sliding window includes N sub-windows, N is greater than or equal to 2, the system state includes the position and the posture of the IMU, and the image observation result includes the observation coordinate value of the landmark point captured by the camera at the system time of the sub-window; the SLAM model is constructed according to the time compensation value, the image observation results and the system state of the sub-window in the current sliding window, where the time compensation value is the time deviation between the time system of the camera and the time system of the IMU; the SLAM model is solved to obtain parameters to be estimated, which include the system state and the time compensation value to be estimated of each sub-window in the current sliding window. In this method, the time compensation value is modeled together with the system state, so that the time compensation value can be continuously iteratively optimized, and the time compensation value is used to compensate the time system of the camera, and the time system of the camera after compensation is used to model the SLAM model. In this way, the estimation result of the SLAM system is more accurate.

The second embodiment of the present disclosure is described with reference to the case where nonlinear optimization iteration is used for the SLAM system, by way of example. The SLAM model constructed by nonlinear optimization iteration includes the visual measurement residual model and the inertial measurement residual model. Among them, the inertial measurement residual model is modeled based on the IMU data, and the visual measurement residual model is modeled by combining the IMU data and the image data.

### (1) Inertial Measurement Residual Model

In this method, before constructing the inertial measurement residual model, it is necessary to obtain the IMU pre-integration of each sub-window according to the IMU data obtained by the IMU measurement, where the IMU pre-integration of the i-th sub-window is the pre-integration result of the IMU data between the system time of the first sub-window and the system time of the i+1-th sub-window.

The SLAM system acquires all the IMU data collected between the i-th sub-window and the i+1-th sub-window, and performs pre-integration on the IMU data to obtain the IMU pre-integration of the sub-window. For example, assuming that the IMU data is collected eight times in total between the i-th sub-window and the i+1-th sub-window, the pre-integration is performed on the eight sets of IMU data as collected.

The 6-axis IMU and the 9-axis IMU are two common types of IMUs. The 6-axis IMU usually consists of a three-axis accelerometer and a three-axis gyroscope. The accelerometer is used to measure the linear acceleration of an object in a three-dimensional space, while the gyroscope is used to measure the angular velocity of an object around three axes. The 9-axis IMU is added with a 3-axis magnetometer relative to the 6-axis IMU. The magnetometer is used to measure the direction of the Earth's magnetic field under the IMU's coordinate system, thus providing additional pose information.

Regardless of whether it is a 6-axis IMU or a 9-axis IMU, the IMU data measured by the IMU [symbol] ludes acceleration values and gyroscope values (which can be replaced by angular velocity), and pre- [symbol] gration is performed on the acceleration values and the gyroscope values to obtain the IMU pre-integration. The obtained IMU pre-integration includes the position change and the posture change of the IMU between the two sub-windows (i.e. from time t₁ to time tᵢ+1). Optionally, the IMU pre-integration may also include the velocity change of the IMU.

In one implementation, the inertial measurement residual for each sub-window is constructed based on the IMU pre-integrations and system states of all sub-windows in the current sliding window, and the inertial measurement residual is represented by the following formula (1)

$${r}_{I , i} = ( {X}_{{I}_{{t}_{i + 1}}} - {X}_{{I}_{{t}_{i}}} ) - {IMUS}_{{t}_{i}} ; \qquad ( 1 )$$

[symbol]

I,i represents the inertial measurement residual of the i-th sub-window,

$${X}_{{I}_{{t}_{i}}}$$

represents the system [symbol] e of the i-th sub-window,

$${X}_{{I}_{{t}_{i + 1}}}$$

represents the system state of the i+1-th sub-window, and IMUSₜ_{ᵢ} represents the IMU pre-integration of the i-th sub-window.

For

$${X}_{{I}_{{t}_{i}}} = {[ {q}_{{I}_{{t}_{i}}}^{T} , {P}_{{I}_{{t}_{i}}}^{T} , {V}_{{I}_{{t}_{i}}}^{T} , {b}_{{a}_{{t}_{i}}}^{T} , {b}_{{g}_{{t}_{i}}}^{T} ]}^{T} ,$$

the system state of the sub-window includes the position, the posture, the velocity, the accelerometer bias and the gyroscope bias of the IMU. Correspondingly, when pre-integration is performed on the IMU data between the two sub-windows, the accelerometer bias is used to correct the acceleration value in the IMU data, and the gyroscope bias is used to correct the gyroscope value in the IMU data.

### (2) Visual Measurement Residual Model

In one implementation, the IMU posture and the IMU position at the time tᵢ−tdᵢ+td in the [symbol] rent sliding window are determined first based on the time compensation values, the system states and [symbol] time compensation values to be estimated corresponding to all the sub-windows in the current sliding window; and then the visual measurement residual of the observed landmark points in the sliding window is constructed based on the IMU posture and IMU position at time tᵢ−tdᵢ+td, extrinsic parameters of the camera, and image observation results. The visual measurement residual is represented by the following equation (2):

$${r}_{i , j} = {z}_{i , j} - π ( R ( {q}_{{t}_{i} - {td}_{i} + td} ) \cdot {}_{C}^{I} R , {P}_{{t}_{i} - {td}_{i} + td} + R ( {q}_{{t}_{i} - {td}_{i} + td} ) . {}^{I} {P}_{C} , {P}_{{L}_{i}} ) \qquad ( 2 )$$

Among them, r_{i,j} represents the visual measurement residual of the j-th landmark point [symbol] erved at the i-th sub-window, z_{i,j} represents the observation coordinate value of the j-th landmark point observed at the i-th sub-window, and the overall

$$π ( R ( {q}_{{t}_{i} - {td}_{i} + td} ) \cdot {}_{C}^{I} R , {P}_{{t}_{i} - {td}_{i} + td} + R ( {q}_{{t}_{i} - {td}_{i} + td} ) \cdot {}^{I} {P}_{C} , {P}_{{L}_{i}} )$$

represents the estimated coordinate value of the j-th landmark point observed at the i-th sub-window. The estimated coordinates value of the j-th landmark point is obtained based on the projection model π (-, -, -) of the camera.

The extrinsic parameters of the camera are used to represent the rotation and translation from the [symbol] era to the IMU, and the extrinsic parameters of the camera include

$${}_{C}^{I} R$$

and ^{I}P_{C}, where

$${}_{C}^{I} R$$

represents [symbol] rotation matrix of the camera relative to the IMU, and ^{I}P_{C} represents the translation vector of the camera relative to the IMU. The extrinsic parameters of the camera can be calibrated offline before the terminal device leaves the factory, or can be calibrated offline by the user. In the embodiment of this application, the extrinsic parameters of the camera are regarded as known quantities when performing SLAM positioning, and the acquisition method of the extrinsic parameters of the camera is not limited.

qₜ_{_{i−td}}_{ᵢ}_{+td} represents the IMU posture at the time tᵢ−tdᵢ+td, Pₜ_{ᵢ}_{-td}_{ᵢ}_{+td} represents the IMU [symbol] ition at the time tᵢ−tdᵢ+td, and P_{L}_{ᵢ} represents the three-dimensional coordinates of the j-th [symbol] mark point. The IMU posture at the time tᵢ−tdᵢ+td determined according to the i-th sub-window is expressed by quaternions qₜ_{ᵢ}_{-td}_{ᵢ}_{+td} in formula (2). It should be clarified that the IMU posture can also be expressed by a rotation matrix, and the rotation matrix and the quaternions can be converted to each other. Therefore, the IMU posture in formula (2) can also be replaced by a rotation matrix.

After obtaining the IMU pose (i.e., the position and the posture) at the time tᵢ-tdᵢ+td in the [symbol] rent sliding window, the camera pose at the time tᵢ−tdᵢ+td can be expressed based on the IMU [symbol] e at the time tᵢ−tdᵢ+td and the extrinsic parameters of the camera. For example, the IMU pose and camera pose can be converted by the following formula (3):

$$\begin{matrix}{}^{G} {P}_{C} = {}^{G} {P}_{I} + {}_{I}^{G} {R}^{I} {P}_{C} , & {}_{C}^{G} R = {}_{I}^{G} R \cdot {}_{C}^{I} R\end{matrix} \qquad ( 3 )$$

[symbol] ^{G}P_{C} represents the camera position, ^{G}P_{I} represents the IMU position,

$${}_{I}^{G} R$$

represents the IMU pose, [symbol] represents the translation vector of the camera relative to the IMU,

$${}_{C}^{G} R$$

represents the camera pose,

$${}_{I}^{G} R$$

[symbol]

resents the IMU pose, and

$${}_{C}^{I} R$$

represents the rotation matrix of the camera relative to the IMU.

The camera position can be the three-dimensional coordinate or translation amount of the camera center in the world coordinate system, the camera pose can be the rotation matrix of rotating the camera coordinate system to the IMU coordinate system, the IMU position can be the three-dimensional coordinate or translation amount of the IMU center in the world coordinate system, and the IMU pose can be the rotation matrix of rotating the IMU coordinate system to the world coordinate system.

For example, the IMU posture and the IMU position at the time tᵢ−tdᵢ+td are determined in [symbol] following manner: determining the IMU posture at the time tᵢ−tdᵢ+td based on the IMU posture, [symbol] IMU velocity, the IMU gyroscope value, the time compensation value, and the time compensation value to be estimated of the i-th sub-window; and determining the IMU position at the time tᵢ−tdᵢ+td based on the IMU position, the IMU velocity, the time compensation value, and the time compensation value to be estimated corresponding to the i-th sub-window.

In one implementation, the IMU posture at the time tᵢ−tdᵢ+td is determined by the following [symbol] mula (4), and the IMU position at the time tᵢ−t_{di}+td is determined by the following formula (5):

$$.. td = {q}_{{t}_{i}} \cdot T ( I + {[ {ω}_{{t}_{i}} * ( td - {dt}_{i} ) ]}_{\times } ) \qquad ( 4 )$$

The SLAM system obtains qₜ_{ᵢ} from the system state of the i-th sub-window and obtains ωₜ_{ᵢ} based [symbol] the IMU data, where qₜ_{ᵢ} represents the IMU posture of the i-th sub-window, I represents the unit [symbol] rix, ωₜ_{ᵢ} represents the gyroscope value measured at the system time of the i-th sub-window, the gyroscope value represents the angular velocity of the IMU, and T(•) represents the conversion of the rotation matrix into a quaternion operation.

$$td = {P}_{{t}_{i}} + {V}_{{t}_{i}} ( td - {dt}_{i} ) \qquad ( 5 )$$

The SLAM system obtains Pₜ_{ᵢ} and Vₜ_{ᵢ} from the system state corresponding to the i-th sub-window, [symbol] where Pₜ_{ᵢ} represents the IMU position of the i-th sub-window and Vₜ_{ᵢ} represents the IMU [symbol] city of the i-th sub-window.

After constructing the inertial measurement residual and the visual measurement residual of each observed landmark point for each sub-window in the current sliding window, Jacobian Matrices of all the inertial measurement residuals and visual measurement residuals in the current sliding window with respect to the system states are respectively calculated; and all the inertial measurement residuals, all the visual measurement residuals, the Jacobian matrices corresponding to the inertial measurement residuals, the Jacobian matrices corresponding to the visual measurement residuals, and the system states in the current sliding window are fed into the nonlinear optimizer for iterative optimization, and the parameter to be estimated is obtained.

The parameter to be estimated includes: the system state and the time compensation value to be estimated of each sub-window in the sliding window; and optionally, the parameter to be estimated further includes three-dimensional coordinates of all the observed landmark points in the sliding window.

The nonlinear optimizer may be General Graph Optimization (g2o), ceres or Georgia Tech Smoothing and Mapping (GSTAM), or other nonlinear optimizers.

Since td in the visual measurement residual model is modeled together with the system state, the term corresponding to td in the Jacobian matrix of the visual measurement residual calculated relative to the system state is a non-zero value when the Jacobian matrix of the visual measurement residual is calculated. Therefore, when the nonlinear optimizer performs iterative solution, td will be iteratively optimized step by step.

After the estimation of the current sliding window is completed, the current sliding window, entirely, slides backward by one window, to obtain a new sliding window. The new sliding window still includes N sub-windows. The new sliding window is used as the current sub-window, and the system state estimation and time compensation value estimation are continued according to the above process.

Referring to FIG. 4, the current sliding window is composed of 7 sub-windows 0-6, and a time compensation value to be estimated is obtained by performing estimation on the current sliding window, and the time compensation value is used as the time compensation value for a sub-window 7. When the sliding window slides once, a new sliding window is composed of sub-windows 1-7.

The third embodiment of the present disclosure is described with reference to the case where the SLAM adopts the Kalman-related filtering solution, by way of example. Compared with nonlinear-optimized SLAM, the SLAM model constructed based on Kalman-related filtering only includes inertial measurement residual model, but does not include visual measurement residual model.

In one implementation, the IMU posture and the IMU position at the time tᵢ−tdᵢ+td in the current sliding window are determined based on the time compensation value, the system state, and the time compensation value to be estimated of the sub-window in the current sliding window; and then the visual measurement residual of the landmark points observed in the sliding window is constructed based on the IMU postures and the IMU positions of all the sub-windows in the current sliding window at the time tᵢ−tdᵢ+td, the extrinsic parameters of the camera, and the image observation results. The visual measurement residual is represented by the following formula (2):

$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) \qquad ( 2 )$$

Among them, r_{i,j} represents the visual measurement residual of the j-th landmark point observed at the i-th sub-window, z_{i,j} represents the observation coordinate value of the j-th landmark point observed at the i-th sub-window,

$${}_{C}^{I} R$$

represents the rotation matrix of thee camera relative to the IMU, ^{I}P_{C} represents the translation vector of the camera relative to the IMU, qₜ_{ᵢ}_{-td}_{ᵢ}_{+td} represents the posture of the IMU at the time tᵢ−tdᵢ+td, Pₜ_{ᵢ}_{-td}_{ᵢ}_{+td} represents the IMU position at the time tᵢ−tdᵢ+td, P_{L}_{ᵢ} represents the three-dimensional coordinates of the j-th landmark point, π0 (-, -, -) represents the projection model of the camera.

For the calculation method of the IMU posture and the IMU position at the time tᵢ−tdᵢ+td, reference can be made to the relevant description of the second embodiment, and will not be described in here.

Accordingly, solving the SLAM model to obtain the parameter to be estimated include: calculating the Jacobian matrices of the visual measurement residuals in the current sliding window with respect to the system states respectively; performing Kalman-related filtering on all the visual measurement residuals, the Jacobian matrices corresponding to the visual measurement residuals, and the system states in the current sliding window, to obtain the parameter to be estimated.

Among them, Kalman-related filtering includes Kalman filtering and extended Kalman filtering, which will not be explained in detail here.

The system state of the sub-window in the SLAM based on Kalman-related filtering solution may be different from the system state of the sub-window in the SLAM based on nonlinear optimization iteration solution, and the parameters to be estimated may also be different. For example, in the SLAM based on Kalman-related filtering solution, the parameters to be estimated do not include the three-dimensional coordinates of the observation points, and the three-dimensional coordinates of the observation points can be obtained by fitting through a triangulation method.

In order to facilitate better implementation of the SLAM positioning method based on timestamp correction according to the embodiment of the present disclosure, the embodiment of the present disclosure further provides a SLAM positioning apparatus based on timestamp correction. FIG. 5 is a schematic structural diagram of a SLAM positioning apparatus based on timestamp correction according to the fourth embodiment of the present disclosure. As shown in FIG. 5, the SLAM positioning apparatus 200 based on timestamp correction may include the following modules.

An acquisition module 21, configured to acquire a time compensation value, an image observation result, and a system state of each sub-window in a current sliding window, where the current sliding window includes N sub-windows, N is greater than or equal to 2, the system state includes an IMU position and an IMU posture, and the image observation result includes an observation coordinate value of a landmark point captured by the camera at a system time of the sub-window.

A modeling module 22, configured to construct a SLAM model based on the time compensation values, the image observation results and the system states of the sub-windows in the current sliding window, where a camera system time corresponding to a system time tᵢ of a i-th sub-window in the SLAM model is tᵢ−tdᵢ+td, where tdᵢ represents the time compensation value used to construct the i-th sub-window, td represents a time compensation value to be estimated, where the time compensation value is a time deviation between a time system of the camera and a time system of the IMU.

A solving module 23, configured to solve the SLAM model to obtain a parameter to be estimated, where the parameter to be estimated includes: the system state and the time compensation value to be estimated of each sub-window in the current sliding window.

In some implementations, the acquisition module 21 is further configured to: acquire an IMU pre-integration of each sub-window based on IMU data measured by the IMU, where the IMU pre-integration of the i-th sub-window is a pre-integration result of the IMU data between the system time of the i-th sub-window and the system time of the i+1-th sub-window.

The modeling module 22 is further configured to perform the following steps:
constructing an inertial measurement residual for each sub-window by the following formula:

$${r}_{I , i} = ( {X}_{{I}_{{t}_{i + 1}}} - {X}_{{I}_{{t}_{i}}} ) - {IMUS}_{{t}_{i}} ,$$

[symbol] _{I,i} represents the inertial measurement residual of the i-th sub-window,

$${X}_{{I}_{{t}_{i}}}$$

represents the system [symbol] e of the i-th sub-window,

$${X}_{{I}_{{t}_{i + 1}}}$$

represents the system state of the i+1-th sub-window, IMUSₜ_{ᵢ} represent the IMU pre-integration of the i-th sub-window;
determining an IMU posture and an IMU position at a time tᵢ−tdᵢ+td according to the time [symbol] pensation value, the system state, and the time compensation value to be estimated of the sub-window [symbol] he current sliding window; and
constructing the visual measurement residual of an observed landmark point in the current sliding window by:

$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$

[symbol] _{i,j} represents the visual measurement residual of the j-th landmark point observed at the i-th sub- [symbol] dow, z_{i,j} represents the observation coordinate value of the j-th landmark point observed at the i-th sub-window,

$${}_{C}^{I} R$$

represents the rotation matrix of the camera with respect to the IMU, ^{I}P_{C} represents the translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents the three-dimensional coordinate of the j-th landmark point, and π (-, -, -) represents a projection model of the camera.

In some implementations, the solving module 23 is further configured to perform the following steps:
calculating Jacobian matrices of all the inertial measurement residuals and all the visual measurement residuals in the current sliding window with respect to the system states, respectively;
feeding all the inertial measurement residuals, all the visual measurement residuals, the Jacobian matrices corresponding to the inertial measurement residuals, the Jacobian matrices corresponding to the visual measurement residuals and the system states in the current sliding window into a nonlinear optimizer for iterative optimization, to obtain the parameter to be estimated.

In some implementations, the non-linear optimizer includes g2o, ceres, or GSTAM.

In some implementations, the modeling module 22 is further configured to perform the following steps:
determining an IMU posture and an IMU position at a time tᵢ−tdᵢ+td according to the time [symbol] pensation value, the system state, and the time compensation value to be estimated of the sub-window [symbol] he current sliding window;
constructing the visual measurement residuals of observed landmark points in the current sliding window by the following formula:

$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$

[symbol] _{i,j} represents the visual measurement residual of the j-th landmark point observed at the i-th sub- [symbol] dow, z_{i,j} represents the observation coordinate value of the j-th landmark point observed at the i-th sup-window,

$${}_{C}^{I} R$$

represents the rotation matrix or the camera with respect to the IMU, ^{I}P_{C} represents the translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents the three-dimensional coordinate of the j-th landmark point, and π (-, -, -) represents a projection model of the camera.

In some implementations, the solving module 23 is further configured to perform the following steps:
calculating Jacobian matrices of the visual measurement residuals in the current sliding window with respect to the system states, respectively;
performing Kalman-related filtering processing on all the visual measurement residuals, the Jacobian matrices corresponding to the visual measurement residuals and the system states in the current sliding window, to obtain the parameter to be estimated.

In some implementations, the Kalman-related filtering includes Kalman filtering or extended Kalman filtering.

In some implementations, the modeling module 22 is further configured to perform the following steps:
determining the IMU posture at the time tᵢ−tdᵢ+td based on the IMU posture, the IMU [symbol] city and the IMU gyroscope value, the time compensation value, and the time compensation value to [symbol] estimated of the i-th sub-window;
determine the IMU position at time tᵢ−tdᵢ+td based on the IMU position, the IMU velocity, time compensation value, and the time compensation value to be estimated of the i-th sub-window.

In some implementations, the IMU pose at the time tᵢ−tdᵢ+td satisfies the following formula:

$${}_{td} = {q}_{{t}_{i}} \cdot T ( I + {[ {ω}_{{t}_{i}} * ( t d - d {t}_{i} ) ]}_{\times } ) ,$$

[symbol]

represents the IMU posture corresponding to the i-th sub-window, I resents the unit matrix, ωₜ_{ᵢ} [symbol] presents the gyroscope value measured at the system time of the i-th sub-window, and T(•) represents [symbol] conversion from the rotation matrix into a quaternion operation.

The IMU position at the time tᵢ−tdᵢ+td satisfies the following formula:

$${}_{td} = {P}_{{t}_{i}} + {V}_{{t}_{i}} ( t d - d {t}_{i} ) ,$$

[symbol]

ₜ_{ᵢ} represents the IMU position corresponding to the i-th sub-window, and Vₜ_{ᵢ} represents the IMU [symbol] city of the i-th sub-window.

In some implementations, the system time is a time under the time system of the IMU as a reference time system.

In some implementations, the system state further includes at least one of: a velocity of the IMU, an accelerometer bias of the IMU, a gyroscope bias of the IMU, and three-dimensional coordinates of the landmark point.

In some implementations, the observation value of the landmark point is the pixel coordinate of the landmark point, or the observation value of the landmark point is the normalize coordinate of the landmark point in the plane of the camera.

It should be understood that, the apparatus embodiments and the method embodiments may correspond to each other, and similar descriptions can refer to the method embodiments. To avoid repetition, they are not repeated here.

The apparatus 200 of an embodiment of the present disclosure has been described above from the perspective of functional modules with reference to the accompanying drawings. It should be understood that the functional module may be implemented in hardware form, by instructions in software form, or by a combination of hardware and software modules. Specifically, each step of the method embodiment in the embodiment of the present disclosure may be completed by an integrated logic circuit of hardware and/or an instruction in the form of software in the processor, and the steps of the method disclosed in conjunction with the embodiment of the present disclosure may be directly embodied as the execution of the hardware decoding processor, or the execution of the combination of hardware and software modules in the decoding processor may be completed. Alternatively, the software module may be located in a mature read-only memory in the art such as random memory, flash memory, read-only memory, programmable memory, electrically erasable and writable programmable register, storage medium, etc. The storage medium is located in memory, and processor reads the information in the memory, and completes the steps in the above-described method embodiment in combination with its hardware.

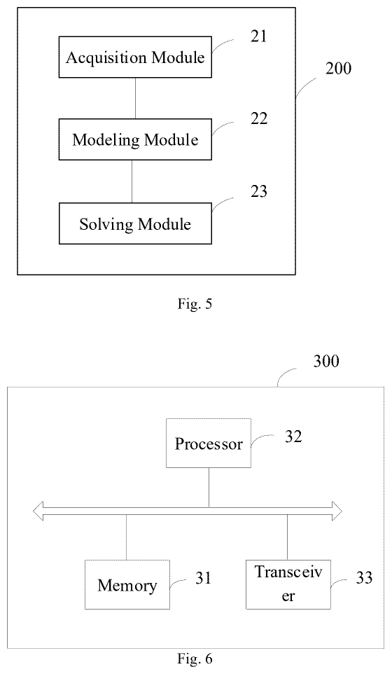

Embodiments of the present disclosure further provide a terminal device. FIG. 6 is a schematic structural diagram of the terminal device according to the fifth embodiment of the present disclosure. As shown in FIG. 6, the terminal device 300 may include a memory 31 and processor 32, the memory 31 is used to store computer program and transmit the program code to the processor 32. In other words, the processor 32 may call and run the computer program from the memory 31 to implement the method in the embodiment of the present disclosure.

For example, the processor 32 may be used to perform the above-described method embodiments in accordance with instructions in the computer program.

In some embodiments of the present disclosure, the processor 32 may include, but is not limited to: general purpose processor, Digital Signal Processor (DSP), Application Specific Integrated Circuit (ASIC), Field Programmable Gate Array (FPGA) or other programmable logic devices, discrete gate or transistor logic devices, discrete hardware components, and the like.

In some embodiments of the present disclosure, the memory 31 includes, but is not limited to: volatile memory and/or non-volatile memory. Among them, the non-volatile memory may be a Read-Only Memory (ROM), a Programmable Read-Only Memory (PROM), an Erasable PROM (EPROM), an Electrically EPROM (EEPROM), or a flash memory. The volatile memory may be a Random-Access Memory (RAM), which serves as an external cache. By way of illustration, but not by way of limitation, many forms of RAM are available, such as static random-access memory (SRAM), dynamic random-access memory (DRAM), synchronous dynamic random-access memory (SDRAM), double data rate synchronous dynamic random-access memory (DDR SDRAM), enhanced synchronous dynamic random-access memory (ESDRAM), synch link dynamic random-access memory (SLDRAM), and direct internal memory bus random-access memory (DR RAM).

In some embodiments of the present disclosure, the computer program may be divided into one or more modules, and the one or more modules are stored in the memory 31 and executed by the processor 32 to complete the method provided by the present disclosure. The one or more modules may be a series of computer program instruction segments capable of performing a particular function, and the instruction segments are used to describe the execution process of the computer program in the terminal device.

As shown in FIG. 6, the terminal device may further include a transceiver 33, which may be connected to the processor 32 or the memory 31, and a display screen (not shown), etc., and the display may be connected to the processor 32 or the memory 31.

Here, the processor 32 may control the transceiver 33 to communicate with other devices, specifically, may transmit information or data to other devices, or receive information or data transmitted by other devices. The transceiver 33 may include a transmitter and a receiver. The transceiver 33 may further include antennas, and the number of antennas may be one or more.

Display screen can be used to display the graphical user interface and receive the operation instructions generated by the user acting on the graphical user interface. Display screen can be for touch display screen, and touch display screen can include display panel and touch panel. Among them, the display panel may be used to display information entered by or provided to the user and various graphical user interfaces of the computer device, which may be composed of graphics, text, icons, videos, and any combination thereof. Alternatively, the display panel may be configured in the form of a Liquid Crystal Display (LCD), an Organic Light-Emitting Diode (OLED), or the like. Touch panel can be used to collect the user's touch operation on or near it (such as the user's operation on touch panel or near touch panel using any suitable object or accessory such as a finger or stylus), and generate corresponding operation instructions, and the operation instructions execute corresponding programs. Optionally, touch panel can include two parts: touch detection apparatus and touch controller. Among them, the touch detection apparatus detects the touch orientation of the user, detects the signal brought by the touch operation, and transmits the signal to the touch controller; Touch controller receives the touch information from the touch detection apparatus, converts it into contact coordinates, then sends it to processor 32, and can receive and execute the commands sent by processor 32. The touch panel may cover display panel, and when the touch panel detects a touch operation on or near it, it is transmitted to the processor 32 to determine the type of touch event, and then the processor 32 provides a corresponding visual output on the display panel according to the type of touch event.

Although not shown in FIG. 6, the terminal device 300 may further include a camera, an IMU, a wireless fidelity WIFI module, a Bluetooth module, an audio module, a power supply module, and the like, and will not be described herein.

It should be understood that the various components in the terminal device are connected by a bus system, where the bus system includes a power supply bus, a control bus, and a status signal bus in addition to a data bus.

The present disclosure also provides a computer storage medium having computer program stored thereon, and when executed by a computer, the computer program enables the computer to perform the method of the method embodiment described above. In other words, an embodiment of the present disclosure further provides a computer program product including an instruction that, when executed by a computer, causes the computer to execute the method of the above-described method embodiment.

The present disclosure also provides a computer program product, the computer program product including computer program, and the computer program is stored in a computer-readable storage medium. Processor of terminal device reads the computer-readable storage medium from computer program, and processor executes the computer program, so that terminal device executes the corresponding procedure described in the above method embodiment, which will not be repeated here for the sake of brevity.

In several embodiments provided herein, it should be understood that the disclosed systems, apparatuses, and methods may be implemented in other ways. For example, the device embodiments described above are merely schematic, for example, the split of the module is only a logical function split, and there may be other split ways in actual implementation, for example, multiple modules or components may be combined or integrated into another system, or some features may be ignored or not implemented. In addition, the coupling or direct coupling or communication connection between each other shown or discussed may be an indirect coupling or communication connection through some interface, device or module, which may be electrical, mechanical or otherwise.

The modules described as separate components may or may not be physically separate, and the components displayed as modules may or may not be physical modules, that is, they may be located in one place or may be distributed over a plurality of network units. Some or all of the modules may be selected according to actual needs to achieve the purpose of the solution of this embodiment. For example, functional modules in various embodiments of the present disclosure may be integrated in one processing module, each module may physically exist separately, or two or more modules may be integrated in one module.

The above is only specific embodiments of the present disclosure, but the scope of protection of the present disclosure is not limited thereto. Any person skilled in the art can easily conceive of changes or substitutions within the technical scope disclosed in the present disclosure, which should be covered within the scope of protection of the present disclosure. Therefore, the scope of protection of the present disclosure should be based on the scope of protection of the claims.

1. A SLAM positioning method based on timestamp correction, applied to a terminal device comprising a camera and an inertial measurement unit (IMU), comprising:
acquiring a time compensation value, an image observation result and a system state of each sub-window in a current sliding window, wherein the current sliding window comprises N sub-windows, N is greater than or equal to 2, the system state comprises an IMU position and an IMU posture, and the image observation result comprises an observation coordinate value of a landmark point captured by the camera at a system time of the sub-window; [symbol]
ting a SLAM model based on time compensation values, the image observation results and the system [symbol] es of the sub-windows in the current sliding window, wherein a camera system time corresponding to [symbol] system time tᵢ of an i-th sub-window in the SLAM mode is tᵢ−tdᵢ+td, wherein tdᵢ represents the time compensation value used to construct the i-th sub-window, td represents a time compensation value to be estimated, and the time compensation value is a time deviation between a time system of the camera and a time system of the IMU; and
solving the SLAM model to obtain a parameter to be estimated, wherein the parameter to be estimated comprises: the system state and the time compensation value to be estimated of each sub-window in the current sliding window.

2. The method according to claim 1, wherein before the constructing a SLAM model based on time compensation values, the image observation results and the system states of the sub-windows in the current sliding window, the method further comprises:
acquiring an IMU pre-integration of each sub-window based on IMU data measured by the IMU, wherein the IMU pre-integration of the i-th sub-window is a pre-integration result of the IMU data between the system time of the i-th sub-window and the system time of an i+1-th sub-window;
wherein the constructing a SLAM model based on time compensation values, the image observation results and the system states of the sub-windows in the current sliding window comprises:
constructing an inertial measurement residual for each sub-window by the following formula:
$${r}_{I , i} = ( {X}_{{I}_{{t}_{i + 1}}} - {X}_{{I}_{{t}_{i}}} ) - {IMUS}_{{t}_{i}} ;$$
wherein r_{I,i} represents the inertial measurement residual for the i-th sub-window,
$${X}_{{I}_{{t}_{i}}}$$
represents the system state of the i-th sub-window,
$${X}_{{I}_{{t}_{i + 1}}}$$
represents the system state of the i+1-th sub-window, IMUSₜ_{ᵢ} represents the IMU pre-integration of the i-th sub-window;
determining the IMU posture and the IMU position at a time tᵢ−tdᵢ+td according to the time compensation value, the system state, and the time compensation value to be estimated of the sub-window in the current sliding window; and
constructing a visual measurement residual for the landmark point observed in the current sliding window by the following formula:
$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$
wherein r_{i,j} represents the visual measurement residual of a j-th landmark point observed at the i-th sub-window, z_{i,j} represents the observation coordinate value of the j-th landmark point observed at the i-th sub-window,
$${}_{C}^{I} R$$
represents a rotation matrix of the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents a three-dimensional coordinate of the j-th landmark point, and π (-, -, -) represents a projection model of the camera.

3. The method according to claim 2, wherein the solving the SLAM model to obtain a parameter to be estimated comprises:
calculating Jacobian matrices of all the inertial measurement residuals and all the visual measurement residuals in the current sliding window with respect to the system states, respectively; and
feeding all the inertial measurement residuals, all the visual measurement residuals, the Jacobian matrices corresponding to the inertial measurement residuals, the Jacobian matrices corresponding to the visual measurement residuals, and the system states in the current sliding window into a nonlinear optimizer for iterative optimization, to obtain the parameter to be estimated.

4. The method according to claim 3, wherein the nonlinear optimizer comprises g2o, ceres or GSTAM.

5. The method according to claim 1, wherein the constructing a SLAM model based on time compensation values, the image observation results and the system states of the sub-windows in the current sliding window comprises:
determining the IMU posture and the IMU position at a time tᵢ−tdᵢ+td according to the time compensation value, the system state, and the time compensation value to be estimated of the sub-window in the current sliding window; and
constructing a visual measurement residual of an observed landmark point in the current sliding window by the following formula:
$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$ [symbol]
r_{i,j} represents the visual measurement residual of a j-th landmark point observed at the i-th sub- [symbol] dow, z_{i,j} represents the observation coordinate value of the j-th landmark point observed at the i-th sub-window,
$${}_{C}^{I} R$$
represents a rotation matrix of the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents a three-dimensional coordinate of the j-th landmark point, and π (-, -, -) represents a projection model of the camera.

6. The method according to claim 5, wherein the solving the SLAM model to obtain a parameter to be estimated comprises:
calculating Jacobian matrices of the visual measurement residuals in the current sliding window with respect to the system states, respectively; and
performing Kalman-related filtering processing on all the visual measurement residuals, the Jacobian matrices corresponding to the visual measurement residuals, and the system states in the current sliding window, to obtain the parameter to be estimated.

7. The method according to claim 6, wherein the Kalman-related filtering processing comprises Kalman filtering processing or extended Kalman filtering processing.

8. The method according to claim 2, wherein the determining the IMU posture and the IMU position at a time tᵢ−tdᵢ+td according to the time compensation value, the system state, and the time compensation value to be estimated of the sub-window in the current sliding window comprises:
determining the IMU posture at the time tᵢ−tdᵢ+td according to the IMU posture, an IMU velocity, an IMU gyroscope value, the time compensation value, and the time compensation value to be estimated of the i-th sub-window; and
determining the IMU position at the time tᵢ−tdᵢ+td according to the IMU position, the IMU velocity, the IMU gyroscope value, the time compensation value, and the time compensation value to be estimated of the i-th sub-window.

9. The method according to claim 8, wherein
the IMU posture at the time tᵢ−tdᵢ+td satisfies the following formula:
$${q}_{{t}_{i} - t {d}_{i} + t d} = {q}_{{t}_{i}} \cdot T ( I + {[ {ω}_{{t}_{i}} * ( t d - d {t}_{i} ) ]}_{\times } ) ,$$ [symbol]
qₜ_{ᵢ} represents the IMU posture corresponding to the i-th sub-window, I represents a unit matrix, [symbol] represents the IMU gyroscope value measured at the system time of the i-th sub-window, and T(•) [symbol] resents a conversion from the rotation matrix to a quaternion operation;
the IMU position at the time tᵢ−tdᵢ+td satisfies the following formula:
$${P}_{{t}_{i} - t {d}_{i} + t d} = {P}_{{t}_{i}} + {v}_{{t}_{i}} ( t d - d {t}_{i} ) ,$$
wherein Pₜ_{ᵢ} represents the IMU position corresponding to the i-th sub-window, and Vₜ_{ᵢ} represents the IMU velocity of the i-th sub-window.

10. The method according to claim 1, wherein the system time is a time under the time system of the IMU used as a reference time system.

11. The method according to claim 1, wherein the system state further comprises at least one of: an IMU velocity, an IMU accelerometer bias, an IMU gyroscope bias, and a three-dimensional coordinate of the landmark point.

12. The method according to claim 1, wherein an observation value of the landmark point is a pixel coordinate of the landmark point, or the observation value of the landmark point is a normalize coordinate of the landmark point in a plane of the camera.

13. A terminal device, comprising a processor and a memory, wherein the memory is configured to store a computer program; and the processor is configured to call and execute the computer program stored in the memory, to perform a SLAM positioning method based on timestamp correction, wherein the terminal device further comprises a camera and an inertial measurement unit (IMU), and the method comprises:
acquiring a time compensation value, an image observation result and a system state of each sub-window in a current sliding window, wherein the current sliding window comprises N sub-windows, N is greater than or equal to 2, the system state comprises an IMU position and an IMU posture, and the image observation result comprises an observation coordinate value of a landmark point captured by the camera at a system time of the sub-window;
constructing a SLAM model based on time compensation values, the image observation results and the system states of the sub-windows in the current sliding window, wherein a camera system time corresponding to the system time tᵢ of an i-th sub-window in the SLAM mode is tᵢ−tdᵢ+td, wherein tdᵢ represents the time compensation value used to construct the i-th sub-window, td represents a time compensation value to be estimated, and the time compensation value is a time deviation between a time system of the camera and a time system of the IMU; and
solving the SLAM model to obtain a parameter to be estimated, wherein the parameter to be estimated comprises: the system state and the time compensation value to be estimated of each sub-window in the current sliding window.

14. The terminal device according to claim 13, wherein in the SLAM positioning method based on timestamp correction, before the constructing a SLAM model based on time compensation values, the image observation results and the system states of the sub-windows in the current sliding window,
the method further comprises:
acquiring an IMU pre-integration of each sub-window based on IMU data measured by the IMU, wherein the IMU pre-integration of the i-th sub-window is a pre-integration result of the IMU data between the system time of the i-th sub-window and the system time of an i+1-th sub-window;
wherein the constructing a SLAM model based on time compensation values, the image observation results and the system states of the sub-windows in the current sliding window comprises:
constructing an inertial measurement residual for each sub-window by the following formula:
$${r}_{I , i} = ( {X}_{{I}_{{t}_{i + 1}}} - {X}_{{I}_{{t}_{i}}} ) - {IMUS}_{{t}_{i}} ;$$
wherein r_{I,i} represents the inertial measurement residual for the i-th sub-Window,
$${X}_{{I}_{{t}_{i}}}$$
represents the system state of the i-th sub-window,
$${X}_{{I}_{{t}_{i + 1}}}$$
represents the system state of the i+1-th sub window, IMUSₜ_{ᵢ} represents the IMU pre-integration of the i-th sub-window;
determining the IMU posture and the IMU position at a time tᵢ−tdᵢ+td according to the time compensation value, the system state, and the time compensation value to be estimated of the sub-window in the current sliding window; and
constructing a visual measurement residual for the landmark point observed in the current sliding window by the following formula:
$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$
wherein r_{i,j} represents the visual measurement residual of a j-th landmark point observed at the i-th sub-window, z_{i,j} represents the observation coordinate value of the j-th landmark point observed at the i-th sub-window,
$${}_{C}^{I} R$$
represents a rotation matrix of the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents a three-dimensional coordinate of the j-th landmark point, and π (-, -, -) represents a projection model of the camera.

15. The terminal device according to claim 14, wherein in the SLAM positioning method based on timestamp correction, the solving the SLAM model to obtain a parameter to be estimated comprises:
calculating Jacobian matrices of all the inertial measurement residuals and all the visual measurement residuals in the current sliding window with respect to the system states, respectively;
feeding all the inertial measurement residuals, all the visual measurement residuals, the Jacobian matrices corresponding to the inertial measurement residuals, the Jacobian matrices corresponding to the visual measurement residuals, and the system states in the current sliding window into a nonlinear optimizer for iterative optimization, to obtain the parameter to be estimated.

16. The terminal device according to claim 15, wherein in the SLAM positioning method based on timestamp correction, the nonlinear optimizer comprises g2o, ceres or GSTAM.

17. The terminal device according to claim 13, wherein in the SLAM positioning method based on timestamp correction, the constructing a SLAM model based on time compensation values, the image observation results and the system states of the sub-windows in the current sliding window comprises:
determining the IMU posture and the IMU position at a time tᵢ−tdᵢ+td according to the time compensation value, the system state, and the time compensation value to be estimated of the sub-window in the current sliding window; and
constructing a visual measurement residual of an observed landmark point in the current sliding window by the following formula:
$${r}_{i , j} = {z}_{i , j} - π ( R ( {q}_{{t}_{i} - t {d}_{i} + td} ) \cdot {}_{C}^{I} R , {P}_{{t}_{i} - t {d}_{i} + t d} + R ( {q}_{{t}_{i} - t {d}_{i} + t d} ) \cdot {}^{I} {P}_{C} , {P}_{{L}_{i}} ) ,$$ [symbol]
r_{i,j} represents the visual measurement residual of a j-th landmark point observed at the i-th sub- [symbol] dow, z_{i,j} represents the observation coordinate value of the j-th landmark point observed at the i-th sub-window,
$${}_{C}^{I} R$$
represents a rotation matrix or the camera with respect to the IMU, ^{I}P_{C} represents a translation vector of the camera with respect to the IMU, qₜ_{ᵢ}_{-td}_{ᵢ}_{+td} represents the IMU posture at the time tᵢ−tdᵢ+td, Pₜ_{ᵢ}_{-td}_{ᵢ}_{+td} represents the IMU position at the time tᵢ−tdᵢ+td, P_{L}_{ᵢ} represents a three-dimensional coordinate of the j-th landmark point, and π (-, -, -) represents a projection model of the camera.

18. The terminal device according to claim 17, wherein in the SLAM positioning method based on timestamp correction, the solving the SLAM model to obtain a parameter to be estimated comprises:
calculating Jacobian matrices of the visual measurement residuals in the current sliding window with respect to the system states, respectively; and
performing Kalman-related filtering processing on all the visual measurement residuals, the Jacobian matrices corresponding to the visual measurement residuals, and the system states in the current sliding window, to obtain the parameter to be estimated.

19. The terminal device according to claim 18, wherein in the SLAM positioning method based on timestamp correction, the Kalman-related filtering processing comprises Kalman filtering processing or extended Kalman filtering processing.

20. A non-transitory computer-readable storage medium, comprising a computer program stored thereon, wherein the computer program is configured to cause a computer to perform a SLAM positioning method based on timestamp correction, wherein the method is applied to a terminal device comprising a camera and an inertial measurement unit (IMU), and the method comprises:
acquiring a time compensation value, an image observation result and a system state of each sub-window in a current sliding window, wherein the current sliding window comprises N sub-windows, N is greater than or equal to 2, the system state comprises an IMU position and an IMU posture, and the image observation result comprises an observation coordinate value of a landmark point captured by the camera at a system time of the sub-window;
constructing a SLAM model based on time compensation values, the image observation results and the system states of the sub-windows in the current sliding window, wherein a camera system time corresponding to system time tᵢ of an i-th sub-window in the SLAM mode is tᵢ−tdᵢ+td, wherein tdᵢ represents the time compensation value used to construct the i-th sub-window, td represents a time compensation value to be estimated, and the time compensation value is a time deviation between a time system of the camera and a time system of the IMU; and
solving the SLAM model to obtain a parameter to be estimated, wherein the parameter to be estimated comprises: the system state and the time compensation value to be estimated of each sub-window in the current sliding window.
